(19) United States
(12) Patent Application Publication
(10) Pub. No.: US 2007/0280544 A1
(43) Pub. Date: Dec. 6, 2007

(54) Method of dividing a picture into parts

(75) Inventors: Masayuki Tokumitsu, Kyoto (JP); Takaaki Hatanaka, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/727,739

(22) Filed: Mar. 28, 2007

(30) Foreign Application Priority Data
Jun. 1, 2006 (JP) 2006-153875

(51) Int. Cl. G06K 9/36; H04N 7/12

(52) U.S. Cl. 382/238; 375/240.12

(57) ABSTRACT

A picture is divided into parts that are coded by different computing resources. The picture consists of blocks, which are the basic units in the coding process; each part includes one or more blocks. To determine how to divide the picture into parts, first a scene differential is calculated for each block, indicating a degree of change that takes place in the block, and a coding processing time is predicted for each block on the basis of its scene differential. The picture is then divided into parts with substantially equal total predicted coding processing times.

### BACKGROUND OF THE INVENTION

1. Field of the Invention

The present invention relates to a method, apparatus, and program for dividing a picture into parts so that the parts can be concurrently coded by a plurality of computing resources.

2. Description of the Related Art

Methods of compressively coding a video signal are under study in which each picture, that is, each frame of the video signal, is divided into a plurality of parts, the different parts are assigned to different computing resources (processing units), each computing resource codes the part of the picture assigned to it, and the coding operation is synchronized at the point at which the entire picture has been coded (see, for example, Japanese Patent No. 3621598).

In a method of this type, the computing resources operate most efficiently when they have equal processing loads, so that the coding of each part of the picture is completed at the same time.

Japanese Patent No. 3621598 therefore presents a method of dividing a picture to be coded into parts, each consisting of one or more uniform horizontal slices, on the basis of information obtained when the preceding picture (the preceding video frame) was coded. Specifically, claim 7 of Japanese Patent No. 3621598 specifies dividing the total coding processing time of the entire preceding picture by the number of slices in the entire picture to calculate the coding processing speed of the entire picture, then dividing the coding processing time of each processing unit by the number of slices it coded to calculate the coding processing speed of each coding unit, and assigning a number of slices to each coding unit according to the ratio of its coding processing speed to the coding processing speed of the entire preceding picture.

This conventional method of dividing the picture to be coded into parts on the basis of the coding processing times in the preceding picture lacks precision, particularly when the areas that require lengthy coding processing shift rapidly from one place to another in successive pictures.

The conventional method also fails to assign parts of appropriate sizes at scene changes, when the picture to be coded differs greatly from the preceding picture. Such scene changes are generally quite common in video pictures. One example of a scene change is shown schematically in FIG. 1, which depicts a sequence of six consecutive video frames labeled P1 to P6.

The pictures in FIG. 1 are divided for coding purposes into two parts at the positions indicated by the horizontal dashed lines. Hatching is used to indicate coding-intensive areas in the pictures. A scene change occurs between pictures P3 and P4. Picture P1 is divided into an upper part and a slightly larger lower part, which takes slightly longer to code. This coding load discrepancy is corrected in picture P2, which is divided into two equal halves that take equally long to code. The same equal division is made in picture P3, again resulting in equal coding loads. Since the equal division worked well in picture P3, it is applied once again in picture P4, the first picture following the scene change. Now, however, the coding-intensive part of the picture is concentrated in the upper left area, so the upper half 4a of the picture takes much longer to code than the lower half 4b.

The dividing line is therefore moved considerably upward in picture P5, but in the meantime the coding-intensive part has moved to the center of the picture and is included entirely in the enlarged lower part of picture P5, which now takes very much longer to code than the upper part. The dividing line is therefore moved back to the center of picture P6, but the coding-intensive part has now moved to the lower right corner, and the lower half of picture P6 still takes much longer to code than the upper half.

As this example shows, the preceding picture can be a very poor guide to the best division of the current picture. This is especially true at scene changes.

### SUMMARY OF THE INVENTION

An object of the present invention is to provide a method, apparatus, and stored program that can divide a picture to be coded into parts that take substantially equally long to code when assigned to separate computing resources.

The picture to be coded is divided into blocks that are coded as single units. The invented method begins by calculating a scene differential for each block, indicating a degree of change that takes place in the block. This may be done by taking a sum of absolute values or squared absolute values of differences between the values of picture elements (pixels) in the block and the values of corresponding pixels in a preceding picture.

Next, a coding processing time is predicted for each block on the basis of its scene differential. The picture is then divided into parts with substantially equal total predicted coding processing times. If there are N parts, for example, where N is a positive integer, and the grand total of the predicted coding processing times of all the blocks in the picture is ΣT, then each part may include a number of contiguous blocks with predicted coding processing times that add up to substantially ΣT/N.

### BRIEF DESCRIPTION OF THE DRAWINGS

In the attached drawings:

FIG. 1 illustrates a sequence of pictures divided into parts by a conventional method;

FIG. 2 is a functional block diagram of an apparatus embodying the invention;

FIG. 3 is a hardware block diagram of the apparatus in FIG. 2;

FIG. 4 is a flowchart illustrating the sequence of processes carried out by the functional blocks in FIG. 2;

FIG. 5 is a more detailed flowchart illustrating the process carried out by the partitioning processor in FIG. 2;

FIGS. 6 and 7 schematically illustrate two pictures divided into macroblocks;

FIG. 8 illustrates the division of the picture in FIG. 6 into two parts; and

FIG. 9 is a flowchart illustrating the sequence of processes carried out by the predictive model updating unit in FIG. 2.

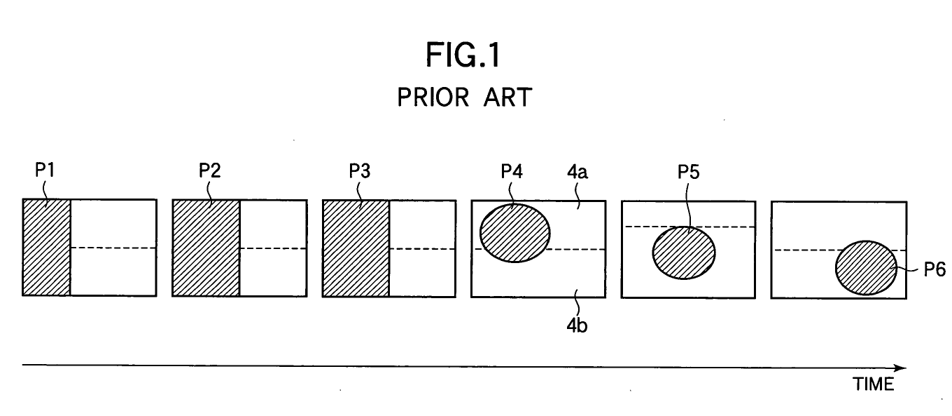

### DETAILED DESCRIPTION OF THE INVENTION

An embodiment of the invention will now be described with reference to the attached drawings, in which like elements are indicated by like reference characters. Although this embodiment is thought to represent the best mode of practicing the invention, it will be evident to the skilled artisan that other modes are possible.

The embodiment is a computing apparatus, more specifically a picture coding apparatus, that executes a program to carry out the invented method of dividing a picture into parts.

The picture to be coded in the embodiment is one picture in a moving picture or video picture sequence, and is coded according to a method that reduces temporal redundancy by taking differences between the values of picture elements (pixels) in the picture and the values of corresponding pixels in the preceding picture in the sequence. Examples of such coding methods are the method specified in recommendation H.264 of the Telecommunication Sector of the International Telecommunication Union (ITU-T) and the MPEG-4 method specified by the Moving Picture Experts Group (MPEG) and the International Organization for Standardization (ISO).

The constituent blocks in the picture in the embodiment are macroblocks, each measuring sixteen pixels vertically and sixteen pixels horizontally, as stipulated in the H.264 and MPEG-4 standards. The abbreviation MB will also be used to denote a macroblock.

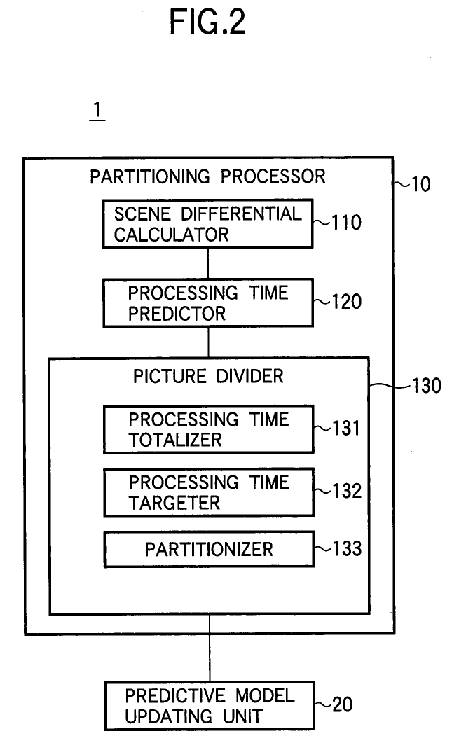

Referring now to FIG. 2, the main functional blocks in the picture coding apparatus are a partitioning processor 10 that divides the picture into parts and a predictive model updating unit 20 that updates a predictive model used by the partitioning processor 10 to calculate predicted processing coding times.

The partitioning processor 10 comprises a scene differential calculator 110, a processing time predictor 120, and a picture divider 130.

The scene differential calculator 110 calculates, for each macroblock in the picture, a scene differential indicating a degree of change that takes place in the macroblock. This scene differential will be described below.

The processing time predictor 120 predicts a coding processing time for each macroblock according to its scene differential as calculated by the scene differential calculator 110.

The picture divider 130 divides the picture into areas (parts) with substantially equal total predicted coding processing times, based on the coding processing time of each macroblock included in each area as predicted by the processing time predictor 120.

The picture divider 130 comprises a processing time totalizer 131, a processing time targeter 132, and a partitionizer 133.

The processing time totalizer 131 adds the coding processing times predicted by the processing time predictor 120 for all of the macroblocks in the picture together to obtain a grand total predicted coding processing time.

If the picture is to be divided into N areas, N being a positive integer, the processing time targeter 132 divides the grand total predicted coding processing time obtained by the processing time totalizer 131 by N to obtain a target value for each part.

The partitionizer 133 selects N groups of mutually contiguous blocks such that the predicted coding processing times of the mutually contiguous blocks in each group sum substantially to the target value obtained by the processing time targeter 132.

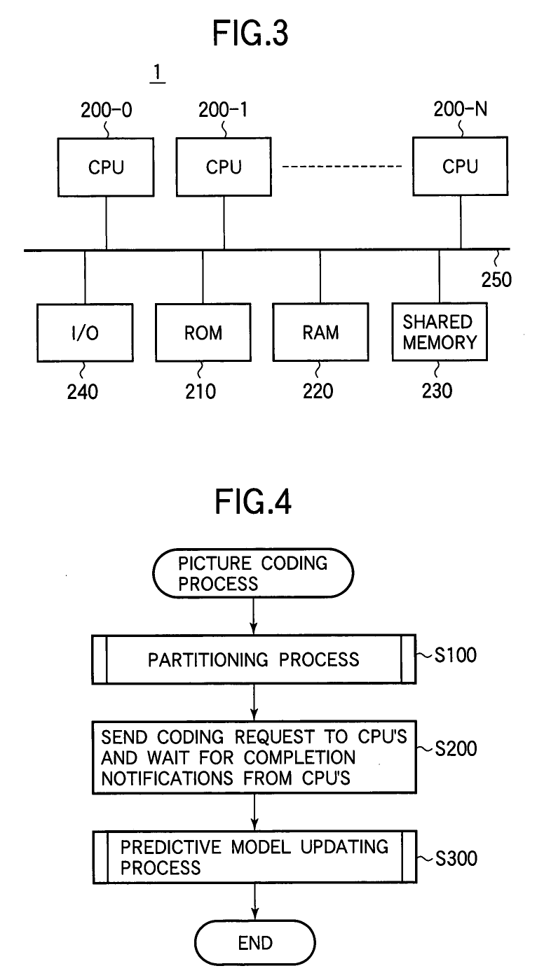

Referring to FIG. 3, the picture coding apparatus 1 comprises N+1 central processing units (CPUs) 200-0 to 200-N, a read-only memory (ROM) 210, a random-access memory (RAM) 220, a shared memory 230, an input/output (I/O) unit 240. These constituent elements are interconnected by a bus 250 by which the N CPUs 200-0 to 200-N access the ROM 210, RAM 220, shared memory 230, and I/O unit 240.

The ROM 210 stores predetermined instructions for performing the functions of the picture coding apparatus 1. The functions of the picture coding apparatus 1 include not only the functions of the partitioning processor 10 and predictive model updating unit 20 but also the function of coding a moving picture according to a predetermined coding algorithm such as the H.264 or MPEG-4 algorithm. The instructions stored in the ROM 210 include instructions for carrying out the partitioning processes shown in FIGS. 4, 5, and 9 below, instructions implementing the relevant coding algorithm, and any other instructions that may be necessary for compressively coding a moving picture.

The RAM 220 stores various types of data that are needed temporarily. These include instructions read from the ROM 210 and results obtained in operations performed during the picture coding process.

The shared memory 230 stores the picture to be coded, various parameters required in the coding process, and the compressively coded data stream. Any of CPUs 200-0 to 200-N can access the shared memory 230.

The I/O unit 240 receives an input picture from an external source and outputs the compressively coded data stream to an external destination.

CPU 200-0 takes charge of the entire coding process and performs the functions of the partitioning processor 10 and the predictive model updating unit 20. CPU 200-0 reads the instructions for performing these functions (illustrated in FIGS. 4, 5, and 9) from the ROM 210 into the RAM 220, and executes them from the RAM 220. The instructions executed by CPU 200-0 include instructions that assign the coding of the parts into which each picture is divided to CPUs 200-1 to 200-N, which CPU 200-0 treats as computing resources, and send requests to code the parts to CPUs 200-1 to 200-N. Upon receiving these requests, CPUs 200-1 to 200-N read instructions for the coding algorithm (e.g., the H.264 or MPEG-4 algorithm) from the ROM 210 into the RAM 220, and execute the instructions from the RAM 220.

Next, the overall control process carried out by CPU 200-0 in the picture coding apparatus 1 will be described with reference to the flowchart in FIG. 4.

In step S100 in FIG. 4, CPU 200-0 divides the picture into parts with substantially equal predicted processing times. In step S200, CPU 200-0 sends requests to code the separate parts to a number of CPUs from 200-1 to 200-N equal to the number of the parts into which the picture is divided, and waits for notifications from these CPUs that they have completed their coding tasks. In step S300, after receiving such notification from all of the CPUs 200-1 to 200-N to which it has sent requests, CPU 200-0 updates parameters in the predictive model it used in calculating the predicted coding processing times in step S100. The sequence of processes from step S100 to step S300 is repeated for each successive frame of the moving picture.

Step S100 includes the calculation of the above-mentioned scene differentials. A scene differential indicates a degree of change from one frame to the next. More specifically, a scene differential indicates the degree of change between the picture to be coded, or part of the picture to be coded, and the immediately preceding picture. The part may comprise a single macroblock or a plurality of macroblocks. In the present embodiment, scene differentials are obtained by calculating the absolute difference between the pixel value of each pixel in the picture and the pixel value of the pixel in the identical position in the preceding picture and taking a sum of the absolute differences calculated for all pixels in the picture, or all pixels in the relevant part of the picture. Accordingly, the greater the scene differential is, the more the picture or part to be coded differs from the preceding picture, or from the identically positioned part of the preceding picture.

Coding algorithms such as the H.264 or MPEG-4 algorithm used in the present embodiment include motion compensation. That is, in taking differences between the values of pixels in the picture to be coded and pixels in the preceding picture, the algorithm allows for motion between the two pictures. To detect such motion, the algorithm includes a search for motion vectors for individual macroblocks.

Motion vectors are found by matching each macroblock in the picture to be coded against blocks of identical size in the preceding picture and calculating a value analogous to the above scene differential. The search starts from the block in the same position as the macroblock and moves on to test matches with blocks in increasingly differing positions, stopping when a sufficiently close match is found or when a limit distance is reached.

If the scene differential of the macroblock is zero, indicating that the macroblock is identical to the block in the same position in the preceding picture, then the motion vector search will end with the first test match. Conversely, if the macroblock has a large scene differential, the search for a closely matching block in the preceding picture may well fail; that is, the search may examine all blocks out to the limit distance, which takes time, without finding a close match. In general, the larger the scene differential is, the longer the motion vector search is likely to last.

For typical moving pictures, the motion vector search accounts for a substantial part of the coding time. The scene differential is accordingly a good predictor of the coding processing time of a macroblock.

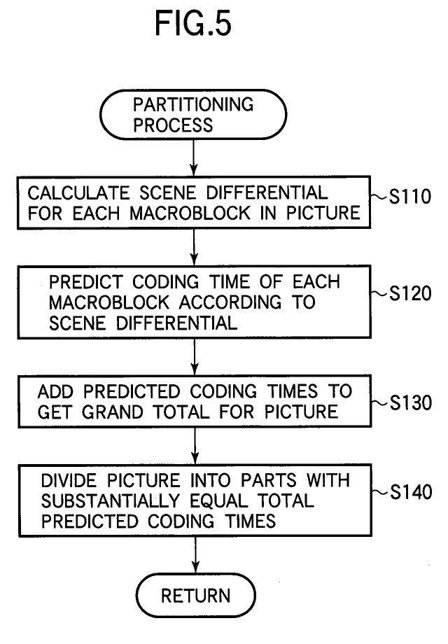

Next, the process carried out by CPU 200-0 in step S100 in FIG. 4 will be described with reference to the more detailed flowchart in FIG. 5.

In step S100, CPU 200-0 operates as the partitioning processor 10 in FIG. 2. The description will accordingly mention the functional elements of the partitioning processor 10, that is, the scene differential calculator 110, the processing time predictor 120, the picture divider 130, and its constituent elements: the processing time totalizer 131, the processing time targeter 132, and the partitionizer 133. Each of these functional elements corresponds to a set of instructions executed by CPU 200-0.

In step S110 in FIG. 5, the scene differential calculator 110 calculates a scene differential for each macroblock in the picture to be coded. Since each macroblock measures sixteen pixels vertically and sixteen pixels horizontally, this calculation includes two hundred fifty-six subtraction operations and a like number of operations that add the resulting positive differences to a cumulative sum, and subtract the resulting negative differences from the cumulative sum.

In step S120, the processing time predictor 120 predicts a coding processing time for each macroblock according to its scene differential. The predictive model used to make the prediction is given by the following equation, in which T is the predicted coding processing time of the macroblock, S is its scene differential value, and a and b are parameters.

T=a×S+b

In step S130, the processing time totalizer 131 in the picture divider 130 adds the predicted coding processing times of all of the macroblocks to obtain a grand total predicted coding processing time of the picture.

In step S140, the processing time targeter 132 in the picture divider 130 sets a target coding processing time for the areas (parts) into which the picture will be divided. If the picture will be divided into N parts, the processing time targeter 132 divides the grand total predicted coding processing time obtained by the processing time totalizer 131 by N to obtain the target value.

Next, the partitionizer 133 in the picture divider 130 selects a first macroblock, assigns it to a first part of the picture, assigns its predicted processing time as the processing time of the first part, and compares the predicted coding processing time of the first part with the target time. If the predicted coding processing time is less than the target time, the partitionizer 133 selects further macroblocks, one by one, each time selecting a macroblock contiguous with one of the macroblocks already included in the first part. Each time a macroblock is added to the first part, its predicted processing time is added to the predicted processing time of the first part, and the predicted processing time of the first part is compared with the target value. This process continues until the predicted processing time of the first part is equal to or greater than the target value, at which point the first part is considered to be complete.

Using the remaining macroblocks, the partitionizer 133 proceeds in the same fashion to define a second part, then a third part, and so on until only one part remains to be defined, at which point all remaining macroblocks are assigned to this last part. If the number of parts is N, this process produces N groups of mutually contiguous blocks such that the predicted coding processing times of the mutually contiguous blocks in each group sum substantially to the target value.

Upon completing the process in step S140, CPU 200-0 proceeds to the process in step S200.

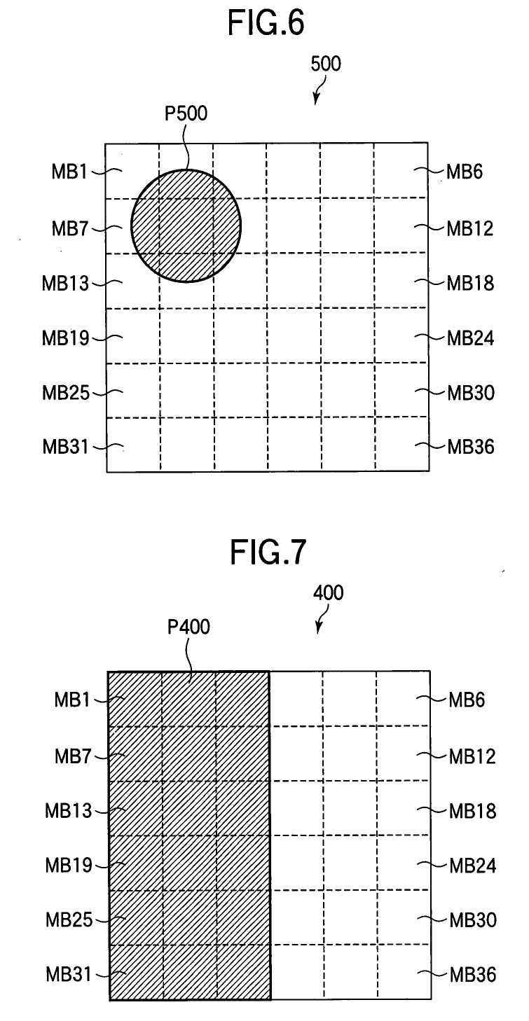

The process carried out in step S100 will be clarified through an example illustrated in FIGS. 6 to 8. The picture 500 in FIG. 6 is the picture to be coded, and the picture 400 in FIG. 7 is the preceding picture. Each picture 400, 500 includes thirty-six macroblocks, numbered MB1 to MB36. The value of N is assumed to be two, so the picture 500 in FIG. 6 will be divided into two parts.

Hatching is used to indicate coding-intensive areas. In FIG. 6, the coding-intensive part P500 of the picture is concentrated in a circular area near the upper left corner of the picture. In FIG. 7, the coding-intensive part P400 of the picture is the left half of the picture.

CPU 200-0 executes the sequence of processes in steps S110 to S140 described below.

In step S110, CPU 200-0 calculates a scene differential for each of the thirty-six macroblocks MB1 to MB36. S1 will denote the scene differential of macroblock MB1, S2 the scene differential of macroblock MB2, . . . , and S36 the scene differential of macroblock MB36. The scene differential is obtained by calculating an absolute difference between the pixel value of each pixel in picture 500 and the pixel value of the pixel in the identical position in the preceding picture 400 and taking a sum of the absolute differences calculated for the pixels in each macroblock.

In step S120, CPU 200-0 predicts a coding processing time for each of macroblocks MB1 to MB36 according to the corresponding scene differentials S1 to S36. The predicted times will be denoted T1 to T36, where T1 is the predicted coding processing time of macroblock MB1, T2 is the predicted coding processing time of macroblock MB2, . . . , and T36 is the predicted coding processing time of macroblock MB36.

In step S130, CPU 200-0 calculates the sum (T1+T2+ . . . +T36) of the predicted coding processing times of all of the macroblocks MB1 to MB36. This sum (denoted ΣT below) is the grand total predicted coding processing time of picture 500.

In step S140, CPU 200-0 divides the picture into parts (contiguous areas) with substantially equal predicted coding processing times of macroblocks included in each part. Since the picture 500 is to be divided into two parts, CPU 200-0 begins by dividing the grand total predicted coding processing time ΣT by two to obtain a target value (ΣT/2) for each part, then proceeds as follows, selecting macroblocks in numerical order from MB1 to MB36. Since there are only two parts, it is only necessary to select macroblocks for the first part.

The first part of picture 500 initially consists of macroblock MB1, so its predicted coding processing time T1 is compared with the target value (ΣT/2). In the present example, CPU 200-0 finds that predicted coding processing time T1 is less than the target value (ΣT/2).

Next CPU 200-0 adds the predicted coding processing times T1 and T2 of macroblocks MB1 and MB2 together and determines whether their sum (T1+T2) is equal to or greater than the target value (ΣT/2). In the present example, the sum of predicted coding processing times T1 and T2 is less than the target value (ΣT/2).

Continuing as described above, CPU 200-0 adds more contiguous macroblocks MB3, MB4, . . . to the first part of picture 500 and compares the sum (T1+T2+T3+T4, . . . ) of their predicted coding processing times with the target value (ΣT/2) until the sum reaches or exceeds the target value (ΣT/2), at which point the CPU 200-0 stops adding macroblocks. If the sum exceeds (ΣT/2), it will be higher than (ΣT/2) by some fraction of the predicted coding processing time of the last macroblock added, so the sum will be substantially equal to (ΣT/2).

In the present example, CPU 200-0 finds that the predicted coding processing times (T1+T2+T3+T4+ . . . +T12) of the first twelve macroblocks MB1, MB2, MB3, MB4, . . . , MB12 sum substantially to the target value (ΣT/2), and makes these twelve macroblocks the first part of picture 500.

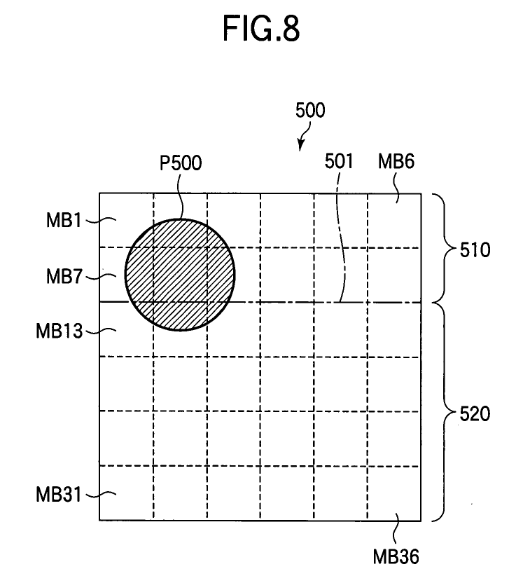

Finally, the CPU 200-0 places the remaining macroblocks MB13, MB14, . . . , MB36 in the second part. FIG. 8 illustrates the boundary line 501 between the first part 510 and the second part 520 of the picture 500. The sum (T13+ . . . +T36) of the predicted coding processing times of the macroblocks MB13, . . . , MB36 included in the second part 520 is also substantially equal to the target value (ΣT/2).

As the total predicted coding processing time of the first part 510 is substantially equal to the total predicted coding processing time of the second part 520, if CPU 200-1 is assigned to the first part 510 and CPU 200-2 is assigned to the second part 520, CPU 200-1 and CPU 200-2 will have substantially equal coding loads.

Since picture 500 follows picture 400 in FIG. 7, the conventional partitioning method would divide picture 500 into a first half including macroblocks MB1 to MB18 and a second half including macroblocks MB19 to MB36. Although the halves would be equal, CPU 200-1 would have to code all of the coding-intensive part P500 of the picture, leading to a sizeable discrepancy in coding loads between computing resources.

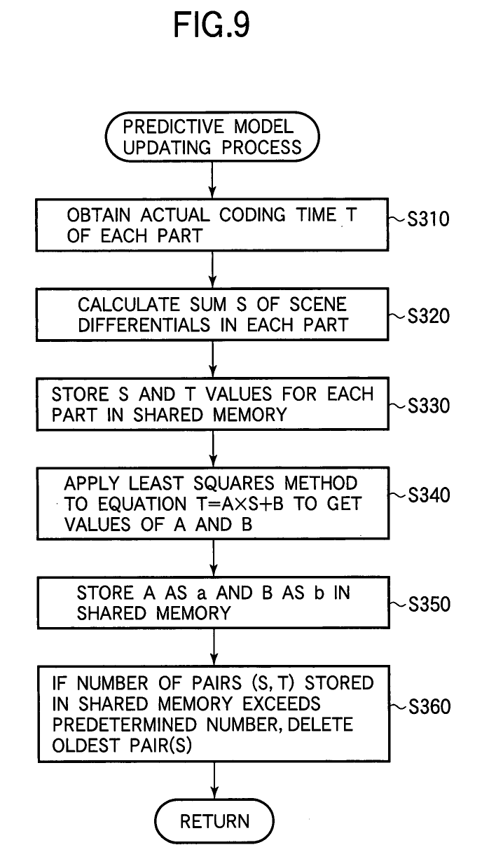

Next, the process in step S300 carried out by CPU 200-0 shown in FIG. 4 will be described with reference to the flowchart in FIG. 9.

In step S300, CPU 200-0 functions as the predictive model updating unit 20 in FIG. 2.

In step S310 in FIG. 9, CPU 200-0 measures or otherwise obtains the actual coding processing time T of each part of the picture. For example, CPU 200-0 may store the time (t1) at which it sends a request to code a part of the picture to a computing resource, and subtract this time (t1) from the time (t2) at which it receives a notification that the coding has been completed to measure the actual coding processing time T (T=t2−t1).

In step S320, CPU 200-0 calculates a sum S of the scene differentials of the macroblocks included in each part of the picture as the scene differential S of the part. In step S330, CPU 200-0 pairs the scene differential S of the part with the actual coding processing time T obtained in step S310, and stores the pair of values (S, T) in the shared memory 230.

In step S340, CPU 200-0 applies the least squares method to the equation, T=A×S+B to obtain values of A and B that best fit the pairs of actual coding processing times T and scene differentials S stored in the shared memory 230. This step is a type of regression analysis, computational methods for which are well known.

In step S350, CPU 200-0 stores the values of A and B obtained as described above as a and b in the shared memory 230, thereby updating the model (T=a×S+b) used to predict the coding processing times.

Finally, in step S360, if the number of pairs of actual coding processing times T and scene differentials S stored in the shared memory 230 exceeds a predetermined number, the oldest pair or pairs are deleted. The shared memory 230 thereby retains a constant number of most recently stored pairs, enabling the predictive model to adapt to changing conditions in the moving picture being coded.

As described above, the present invention provides a way to predict the coding processing times of different parts of a picture in advance, instead of simply assuming that these times will be the same as in the preceding picture and taking corrective action when the assumption turns out to be wrong. Even at scene changes, accordingly, the present invention can divide a picture into parts that take substantially equally long to code.

Although the invention requires the calculation of scene differentials, since this calculation is analogous to a calculation used in searching for motion vectors, the calculated scene differentials can be stored in the shared memory 230 or RAM 220 and used to speed up the motion vector search in the coding process.

In a variation of the above embodiment, the scene differential is obtained by calculating the squared absolute difference between the pixel value of each pixel in the picture to be coded and the pixel value of the pixel in an identical position in the preceding picture and summing the squared absolute differences.

In another variation, the target value is set slightly below the grand total divided by the number of parts (ΣT/N). Alternatively, the target value may be adjusted during the partitioning process according to the combined total coding processing time of the remaining macroblocks and the number of parts to which they are to be assigned.

In still another variation, when the total predicted coding time of a part exceeds the target value, the partitionizer decides, depending on the fraction of the predicted coding time of the last macroblock added to the part, whether to leave the last macroblock in the part or place that macroblock in the next part.

In yet another variation, the blocks from which the parts of the picture are assembled are horizontal slices instead of macroblocks.

In a further variation, the predictive model is updated at intervals of two pictures or more, instead of being updated after every picture. The update may be made while the computing resources are coding the next picture.

The present invention is applicable to any system including a plurality of computing resources that code different parts of a picture concurrently. The computing resources may be different computers, different integrated circuit chips, or different parts of a single integrated circuit chip.

The processing unit that performs the partitioning and model updating functions may also operate as one of the computing resources and code one of the parts of the picture. For example, the invention can be applied in this way in a dual core processor chip.

The present invention can also be practiced in picture-coding software that runs on a computing device or system of any of the types described above.

For certain types of coding algorithms, the invention is also applicable to the coding of still pictures with, for example, the difference between the maximum and minimum pixel values in a block being used as the scene differential of the block.

Those skilled in the art will recognize that further variations are possible within the scope of the invention, which is defined in the appended claims.

What is claimed is:

1. A method of dividing a picture into parts to be coded concurrently by a plurality of computing resources, the picture being made up of a plurality of blocks, each block being coded as a single unit, the method comprising:
calculating for each said block a scene differential indicating a degree of change that takes place in the block;
predicting a coding processing time for each said block according to its scene differential; and
dividing the picture into parts with substantially equal total predicted coding processing times, based on the predicted coding processing time of each block included in each part.

2. The method of claim 1, wherein each said part includes one or more blocks and the total predicted coding processing time of each part is the sum of the predicted coding processing times of the blocks included in the part.

3. The method of claim 2, wherein the picture is divided into N parts, N being a positive integer, and dividing the picture into parts further comprises:
adding the predicted coding processing times of all of the blocks in the picture together to obtain a grand total predicted coding processing time;
dividing the grand total predicted coding processing time by N to obtain a target value; and
selecting N groups of mutually contiguous blocks such that the predicted coding processing times of the mutually contiguous blocks in each group sum substantially to the target value.

4. The method of claim 1, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and calculating the scene differential further comprises:
calculating an absolute difference between the pixel value of each pixel and the pixel value of the corresponding pixel in the preceding picture; and
calculating, for each said block, a sum of the absolute differences calculated for the pixels in the block.

5. The method of claim 1, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and calculating the scene differential further comprises:
calculating a squared absolute difference between the pixel value of each pixel and the pixel value of the corresponding pixel in the preceding picture; and
calculating, for each said block, a sum of the squared absolute differences calculated for the pixels in the block.

6. The method of claim 1, wherein predicting a coding processing time includes using a parameter to operate on the scene differential, the method further comprising:
measuring an actual coding processing time of each said part;
making comparisons by comparing the measured actual coding processing time of each said part with its total predicted coding processing time; and
updating the parameter according to results of the comparisons.

7. An apparatus for dividing a picture into parts to be coded concurrently by a plurality of computing resources, the picture being made up of a plurality of blocks, each block being coded as a single unit, the apparatus comprising:
a scene differential calculator for calculating, for each said block, a scene differential indicating a degree of change that takes place in the block;
a processing time predictor for predicting a coding processing time for each said block according to its scene differential; and
a picture divider for dividing the picture into parts with substantially equal total predicted coding processing times, based on the predicted coding processing time of each block included in each part.

8. The apparatus of claim 7, wherein each said part includes one or more blocks and the total predicted coding processing time of each block is the sum of the predicted coding processing times of the blocks included in the part.

9. The apparatus of claim 8, wherein the picture is divided into N parts, N being a positive integer, and the picture divider further comprises:
a processing time totalizer for adding the predicted coding processing times of all of the blocks in the picture together to obtain a grand total predicted coding processing time;
a processing time targeter for dividing the grand total predicted coding processing time by N to obtain a target value; and
a partitionizer for selecting N groups of mutually contiguous blocks such that the predicted coding processing times of the mutually contiguous blocks in each group sum substantially to the target value.

10. The apparatus of claim 7, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and the scene differential calculator calculates, for each said block, a sum of absolute differences between the pixel values of the pixels in the block and the pixel values of the corresponding pixels in the preceding picture.

11. The apparatus of claim 7, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and the scene differential calculator calculates, for each said block, a sum of squared absolute differences between the pixel values of the pixels in the block and the pixel values of the corresponding pixels in the preceding picture.

12. The apparatus of claim 7, wherein the processing time predictor predicts the coding processing time by using a parameter to operate on the scene differential, the apparatus further comprising a predictive model updating unit that measures an actual coding processing time of each said part, makes comparisons by comparing the measured actual coding processing time of each said part with its total predicted coding processing time, and updates the parameter according to results of the comparisons.

13. A machine-readable medium storing machine-executable instructions for dividing a picture into parts to be coded concurrently by a plurality of computing resources, the picture being made up of a plurality of blocks, each block being coded as a single unit, the instructions comprising:
instructions for calculating for each said block a scene differential indicating a degree of change that takes place in the block;
instructions for predicting a coding processing time for each said block according to its scene differential; and
instructions for dividing the picture into parts with substantially equal total predicted coding processing times, based on the predicted coding processing time of each block included in each part.

14. The machine-readable medium of claim 13, wherein each said part includes one or more blocks and the total predicted coding processing time of each block is the sum of the predicted coding processing times of the blocks included in the part.

15. The machine-readable medium of claim 14, wherein the picture is divided into N parts, N being a positive integer, and the instructions for dividing the picture into parts include:
instructions for adding the predicted coding processing times of all of the blocks in the picture together to obtain a grand total predicted coding processing time;
instructions for dividing the grand total predicted coding processing time by N to obtain a target value; and
instructions for selecting N groups of mutually contiguous blocks such that the predicted coding processing times of the mutually contiguous blocks in each group sum substantially to the target value.

16. The machine-readable medium of claim 13, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and the instructions for calculating the scene differential include:
instructions for calculating an absolute difference between the pixel value of each pixel and the pixel value of the corresponding pixel in the preceding picture; and
instructions for calculating, for each said block, a sum of the absolute differences calculated for the pixels in the block.

17. The machine-readable medium of claim 13, wherein the picture follows a preceding picture in a moving picture sequence, each block comprises a plurality of pixels having respective pixel values, the preceding picture is divided into corresponding blocks comprising corresponding pixels with pixel values, the pixels in each block and the corresponding pixels in the corresponding block in the preceding picture are in identical positions, and the instructions for calculating the scene differential include:
instructions for calculating a squared absolute difference between the pixel value of each pixel and the pixel value of the corresponding pixel in the preceding picture; and
instructions for calculating, for each said block, a sum of the squared absolute differences calculated for the pixels in the block.

18. The machine-readable medium of claim 13, wherein the instructions for predicting the coding processing time include an instruction using a parameter to operate on the scene differential, the machine-executable instructions further comprising:
instructions for measuring an actual coding processing time of each said part;
instructions for making comparisons by comparing the measured actual coding processing time of each said part with its total predicted coding processing time; and
instructions for updating the parameter according to results of the comparisons.
